(19) United States
(12) Patent Application Publication
(10) Pub. No.: US 2009/0306251 A1
(43) Pub. Date: Dec. 10, 2009

(54) FLY ASH-BASED FLOOR PATCHING COMPOSITION

(75) Inventor: Hubert C. Francis, Lithonia, GA (US)

Correspondence Address: Georgia-Pacific LLC, 133 Peachtree Street NE - GA030-41, ATLANTA, GA, 30303, US

(73) Assignee: GEORGIA-PACIFIC GYPSUM LLC, Atlanta, GA (US)

(21) Appl. No.: 12/133,868

(22) Filed: Jun. 5, 2008

(51) Int. Cl. C04B 28/06

(52) U.S. Cl. 524/5; 524/8

(57) ABSTRACT

A floor patching composition for mixing with water to produce a self-leveling slurry that quickly hydrates to form an acceptable patch comprising a dry mixture of (1) Class C fly ash, (2) a calcium aluminate cement, (3) an organic binder along with (4) a cellulose ether, in part to facilitate mixing of the dry ingredients and preferably (5) an antimicrobial preservative and (6) metakaolin clay.

### BACKGROUND OF THE INVENTION

1. Field of the Invention

The present invention describes a floor patching composition that when mixed with water to produce a self-leveling slurry quickly hydrates to provide a smooth concrete-like surface for flooring so as to facilitate providing either a smooth finished floor surface or a level surface suitable for application of other flooring or floor covering materials such as carpet, tile or vinyl flooring. The floor patching composition is characterized by the inclusion of a significant amount of Class C fly ash.

2. Description of Related Art

Portland cement-based compositions have been widely used in various floor patching, floor leveling, and floor smoothing applications in order to smooth out uneven areas and to produce a level surface. Leveling uneven areas of a floor prepares the floor for the subsequent application of floor coverings such as carpeting, tiling, vinyl floor coverings, linoleum, parquet, wood, etc.

U.S. Pat. No. 6,106,608 describes a composition designed to be added to a typical mortar for producing a floor leveling and patching composition. The composition comprises about 0.2 to 3.0% by weight of a dispersing agent, about 0.2 to 2.5% by weight of an alkali tartrate, and about 0.2 to 3.0% by weight of an alkali carbonate on a total weight of mortar basis. This composition is added in an amount of about 6% by weight of the mortar. A suitable mortar generally contains a suitable hydraulic binder composed of one or more binding agents such as calcium aluminate cement, calcined gypsum, and Portland cement. The blended materials are then admixed with water to achieve the desired viscosity and applied to the floor.

U.S. Pat. No. 4,661,159 describes a composition for producing a floor underlayment that includes an alpha calcium sulfate hemihydrate (alpha gypsum), Portland cement, fly ash, and a beta calcium sulfate hemihydrate (beta gypsum). The composition may also include a small amount of a retarder, defoamer, and superplasticizer and is mixed with water and sand to produce a pourable, self-leveling and quick-setting slurry. A preferred formulation is said to contain 45%-55% by weight beta gypsum; 20% to 30% by weight alpha gypsum; about 5% fly ash by weight; and about 20% Type II Portland Cement by weight.

In U.S. Pat. No. 5,424,099 the combination of a hydraulic cement, 10 to 20% by wt., such as Portland cement, alumina cement, fly ash, blast furnace slag and silica fume; alpha calcium sulfate hemihydrate (alpha gypsum) 70 to 90% by wt., along with a superplasticizer is purportedly used as a self-leveling floor underlayment. Exemplary superplasticizers include naphthalene sulfonates; naphthalene sulfonate-formaldehyde condensates; calcium lignosulfonate; melamine sulfonate-formaldehyde condensates; and polycarboxylic acids.

U.S. Pat. No. 5,439,518 describes a composition based on a lime-containing fly ash that also can be formulated for floor underlayment applications. In the floor underlayment application, the ingredients include about 10-89 wt. % of a lime-containing fly ash, preferably 45 to 54 wt. %; about 10-89 wt. % hydratable gypsum, preferably 45-54 wt. % and at least about 0.05 wt. % of an additive selected from: a setting retarder, dispersant, and/or pigment. The patent suggests that alpha gypsum hemihydrate and beta gypsum hemihydrate can be used interchangeably without significantly impacting the properties of the resulting set product, although alpha hemihydrate is preferred from a commercial perspective.

In U.S. Pat. No. 5,685,903 and U.S. Pat. No. 5,718,759 a composition, also identified as being useful for a floor underlayment, is described containing about 20 wt. % to about 75 wt. % calcium sulfate beta-hemihydrate (beta gypsum), preferably 30 to 50 wt. %; about 10 wt. % to about 50 wt. % Portland cement, preferably 6 to 25 wt. %; about 4 wt. % to about 20 wt. % silica fume, preferably 4 to 8 wt. %; and about 1 wt. % to about 50 wt. % pozzolanic aggregate, preferably 1 to 15 wt. %. The Portland cement component may also be a blend of Portland cement with fly ash and/or ground blast slag.

More recently, U.S. Pat. No. 7,056,964 proposed a composition useful for preparing a floor underlayment containing about 50 wt. % to about 98 wt. % calcium sulfate hemihydrate, at least 25% being calcium sulfate beta-hemihydrate (beta gypsum); about 0.05 wt. % to about 50 wt. % of an enhancing component, such as Portland cement, fly ash, blast furnace slag and silica fume; and a polycarboxylate dispersant comprising a copolymer of an oxyalkylene-alkyl ether and an unsaturated dicarboxylic acid. The invention was purportedly based on the patentee's observation that the fluidity of conventional dispersants, such as sulfonated melamines and sulfonated naphthalenes was not sufficient to permit the substitution of beta gypsum for alpha gypsum in high strength flooring applications, a result permitted only by the use of the more expensive polycarboxylate dispersants comprising a copolymer of an oxyalkylene-alkyl ether and an unsaturated dicarboxylic acid.

### SUMMARY OF THE INVENTION

In one embodiment, the present invention relates to a floor patching composition comprising a dry blend of ingredients (powder) to be mixed with water to form a self-leveling slurry that hydrates to form a floor patch, the ingredients comprising:
(1) about 70 to 95% by weight of Class C fly ash;
(2) about 1.5 to 15% by weight of a calcium aluminate cement;
(3) about 0.5 to 5% by weight of an organic binder; and
(4) about 0.05 to 1.0% by weight of a cellulose ether.

In one embodiment, the present invention relates to a floor patching composition comprising a dry blend of ingredients (powder) to be mixed with water to form a self-leveling slurry that hydrates to form a floor patch, the ingredients comprising:
(1) about 70 to 95% by weight of Class C fly ash;
(2) about 1.5 to 15% by weight of a calcium aluminate cement;
(3) about 0.5 to 5% by weight of an organic binder;
(4) about 0.05 to 1.0% by weight of a cellulose ether;
(5) about 0.01 to 0.5% by weight of an antimicrobial preservative, and
(6) about 0.5 to 15% by weight of metakaolin clay.

### DETAILED DESCRIPTION OF THE INVENTION

The present invention combines as dry ingredients (1) Class C fly ash, (2) a calcium aluminate cement and (3) an organic binder along with (4) a cellulose ether, in part to facilitate mixing of the dry ingredients and also preferably (5) an antimicrobial preservative and (6) a metakaolin clay to produce a floor patching composition that when mixed with water to produce a self-leveling slurry quickly hydrates to form a floor patch. In particular, the floor patching composition of the present invention comprises a dry blend of ingredients comprising:
(1) about 70 to 95% by weight of Class C fly ash;
(2) about 1.5 to 15% by weight of a calcium aluminate cement;
(3) about 0.5 to 5% by weight of an organic binder; and
(4) about 0.05 to 1.0% by weight of a cellulose ether,

which when mixed with water to form a self-leveling slurry, rapidly hydrates to form a floor patch.

The floor patching composition is substantially gypsum free. In other words, calcined gypsum is neither a necessary, nor a desired additive. In particular, the composition will contain less than 5% by weight calcined calcium sulfate, preferably less tha 1% by weight and usually absolutely none. The composition is environmentally friendly, it is fast drying, it is quick setting, it exhibits good early strength and it bonds well to the underlying substrate.

In another embodiment, the composition of the present invention further includes as additional components (5) about 0.01 to 0.5% by weight of an antimicrobial preservative, and (6) metakaolin clay in an amount of between 0.5 to 15% by weight of the composition. The addition of the metakaolin serves to improve the plasticity and workability of the formulation, in addition to its pozzolanic property.

The present invention is based on applicant's discovery that with relatively minor amounts of a cement additive (calcium aluminate cement) and an organic binder (and in the absence of any added gypsum), one can take advantage of the cementitious and pozzolanic behaviors of Class C fly ash in formulating an acceptable floor patching composition based predominately on what otherwise constitutes a waste product produced by burning coal.

The major component of the floor patch composition of the present invention is Class C fly ash. As noted, fly ash is one of the waste products or residues produced by burning coal in coal fired power stations. Three of the common constituents of fly ash are silica, alumina and lime. ASTM C618 defines two classes of fly ash: Class F fly ash, usually derived from the burning of anthracite or bituminous coal and Class C fly ash, usually derived from the burning of lignite or subbitumenous coal. Class F fly ash is pozzolanic, contains less than 10% lime (CaO), usually no more than 2-4%, and has little or no cementacious properties on its own. Class C fly ash contains more than 10% lime, and can be as high as 26%, and as a result has some self-cementing properties as well as pozzolanic properties.

As used herein, the phrase “Class C fly ash” is intended to embrace any fly ash that has more than 10% lime (either as produced and recovered directly from the combustion of coal, or as modified through the subsequent addition of lime) and exhibits both self-cementing properties and pozzolanic properties.

Pozzolanic, as defined by ASTM C 593 (1990, ASTM C 593-89, Annual Book of ASTM Standards, Vol. 04.02), is “a siliceous or alumino-siliceous material that in itself possesses little or no cementitious value but that in finely divided form and in the presence of moisture will chemically react with alkali and alkaline earth hydroxides (lime—CaO) at ordinary temperatures to form or assist in forming compounds possessing cementitious properties.”

As noted above, the floor patch composition of the present invention contains at least 70% by weight Class C fly ash and up to about 95% Class C fly ash. Usually, the floor patch composition will contain between 80% and 90% by weight Class C fly ash. Applicant has determined that as long as a minor amount of both a calcium aluminate cement and an organic binder are added to the Class C fly ash, the composition sets rapidly to form a strong and adherent patch.

Thus, in addition to the Class C fly ash, another required component of the floor patch composition of the present invention is a calcium aluminate cement. In the absence of the calcium aluminate cement component, the hardening rate of the Class C fly ash would be somewhat encumbering its application in a typical floor patching application. However, applicant has determined that only a minor amount of the calcium aluminate cement is needed, i.e., from about 1.5 to 15% by weight of the composition, to accelerate the hydration and curing of the fly ash-based composition of the present invention to a sufficient extent to make the composition suitable for floor patching applications. Often the calcium aluminate cement will be used in an amount of between about 5 and 12% by weight.

Another benefit of the calcium aluminate cement is its stabilizing effect on the setting and curing behavior of the fly ash. As a waste product, fly ash often exhibits variable properties, especially after the passage of time that inevitably follows the manufacture and storage of a floor patching composition. The addition of calcium aluminate cement to the fly ash helps to reduce and possibly eliminate such variations, providing the floor patching composition with more uniformity in its performance than might otherwise have been expected from a product based predominantly on fly ash.

Calcium aluminate cement (hereafter CAC), and also known by other designations including Fondu cement or Ciment Fondu, is a cement based on calcium aluminates, rather than calcium silicates, which are the main constituents of Portland cement. CAC is generally made from fused and crushed mixtures of bauxite and limestone (alternatively alumina and lime). While CAC has a setting time similar to that of Portland cement, it hardens much more rapidly. As a result, CAC achieve a high early compressive strength (it has been reported that the initial strength of CAC after one day is higher than that of Portland cement after 28 days). Because CAC does not typically release free lime during its hydration, it was somewhat surprising that its combination with Class C fly ash would produce a composition suitable for floor patching applications, especially when used in only a minor amount as required by the present invention.

The other binder component employed in the floor patching composition of the present invention is an organic binder. The organic binder, like the CAC component, is also used in a minor amount relative to the main Class C fly ash constituent. In particular, the organic binder is included in the composition in an amount between about 0.5 and 5% by weight of the composition and usually in an amount of between about 1 and 3% by weight. The organic binder is added as a finely divided solid and can be selected from materials as ethylene-vinyl-acetate copolymer (EVA), styrene-butadiene-rubber (SBR), styrene-butadiene-styrene (SBS), ethylene-vinyl-chloride (EVCl), poly-vinylidene-chloride (PVdC), modified poly-vinyl-chloride (PVC), poly-vinyl-alcohol (PVOH), and poly-vinyl-acetate (PVA). One way of obtaining suitable solids for such materials is by spray drying a latex of the corresponding binder.

The organic binder adds tack to the composition and helps to strengthen the bond between the patch composition and the floor being patched.

In part to facilitate the mixing of the three binder components of the floor patch composition of the present invention, the composition also includes a nonionic cellulose ether in an amount of about 0.05 to 1% by weight of the composition. Cellulose ethers useful in this invention are the products of the etherification of cellulose with a variety of etherifying agents. Cellulose is a naturally occurring, high polymeric carbohydrate composed of anhydro-glucose units. Cellulose is etherified by the reaction of the free hydroxyl groups of the anhydro-glucose units with etherifying agents. The common etherifying agents useful to prepare a cellulose ether are alkyl halides and alkylene oxides.

Such nonionic cellulose ethers may include methylcellulose, ethylcellulose, hydroxymethylcellulose, hydroxyethylcellulose, carboxymethylcellulose, carboxyethylcellulose, hydroxypropylcellulose, hydroxypropyl methyl cellulose, benzyl hydroxyethyl cellulose and phenyl hydroxyethyl cellulose, and mixtures thereof. Such water-soluble cellulose ethers may exhibit a viscosity of 1,500 cps to 100,000 cps and often between 6,000 cps to 20,000 cps, in 2% by weight aqueous solution and measured at 25° C., but viscosities outside these ranges are suitable in certain applications.

A particularly suitable cellulose ether for use in the present floor patch application is Methocel® 228 cellulose ether (believed to be a lower viscosity, finely ground hydroxypropyl methylcellulose) available from the Dow Chemical Company. Other cellulose ethers such as hydroxyethyl cellulose available under the trade name “Cellosize” from Union Carbide Corporation; “Tylose” from American Hoechst; “Klucel” from Hercules Corporation; and benzyl hydroxyethyl or phenyl hydroxyethyl cellulose ethers from Hercules Chemical Co. may also be suitable depending on the particular composition.

In addition to providing lubricity to facilitate a thorough mixing of the dry ingredients of the floor patching composition of the present invention, the cellulose ether component also improves the workability and consistency of the slurry or paste obtained by incorporating water into the dry composition making spreading easier and increasing efficiency. The cellulose ether also increases water retention which prolongs working time and facilitates proper setting of the cementitious mixture, allowing the cured composition to achieve its highest mechanical strength. By providing a desirable effect on the drying rate of the setting slurry, the cellulose ether also helps to minimize the formation of cracks in the cured composition.

An optional, though often a preferred constituent of the composition is an antimicrobial preservative such as a mildicide or a fungicide. An antimicrobial preservative is preferably included in the composition in an amount of about 0.1 to 0.5% by weight of the composition. The inclusion of this ingredient in the composition ensures the long term stability of the composition, notwithstanding the inclusion of both a cellulose ether and an organic binder in the mixture. Suitable antimicrobial preservatives for use in the composition of the present invention will be apparent to those skilled in the art and include preservatives available under the Mergal® and Polyphase® lines of preservatives available from Troy Corporation. Another suitable preservative is Vancide® MZ 96 available from the R.T. Vanderbilt Company, Inc. Some of these antimicrobial preservatives are supplied in a solid form while others are available as liquids. Given the low level at which the preservative is included in the composition, the state in which it is supplied does not prevent the preparation of the overall composition as a dry blend of solids or powder.

Another optional ingredient of the floor patch composition of the present invention is metakaolin clay. Metakaolin clay is a dehydroxylated (dehydrated) form of kaolinite (kaolin clay). Metakaolin clay is formed by heating (calcining) kaolinite (e.g., china clay or kaolin clay) between about 500 to 800° C., more usually between 650 to 700° C. The dehydoxylation (dehydration) that occurs at this temperature produces an amorphous, highly pozzolanic material. Highly reactive metakaolin is available from Advanced Cement Technologies, LLC, Blaine, Washington, USA and from BASF (previously Engelhard Corporation), New Jersey, USA. Metakaolin clay can be used in the floor patch composition in an amount up to about 15% by weight of the composition. When used, metakaolin clay is usually added in an amount of about 2.5 to 8% by weight.

Another ingredient that can optionally be included in the floor patch composition of the present invention is a set retarder. If included, a set retarder would be present in the mix of dry ingredients in an amount of about 0.02 to 1% by weight, usually from about 0.05 to 0.3%. When used, the presence of a set retarder would increase the working time of the aqueous slurry before it sets. With the addition of a set retarder, there would be an increase in the time available for properly mixing the composition with water and distributing the resulting slurry to the application area of a job site without premature setting. Conventional gypsum setting retarders, such as sodium citrate and commercially available lignin-type retarders are suitable for use in the mixture of the present invention. A preferred retarder is sodium citrate because it can be used very effectively in small amounts as compared to other retarders without adversely affecting desired characteristics of the set composition.

Sometime the floor composition of the present invention will be mixed with water and with an aggregate such as sand and the resulting slurry will be deposited in any uneven or damage area of the flooring to provide a smooth and level surface. Any kind of mixing apparatus may be used to combine the composition with water to make the slurry. If sand is also added, for example to extend the yield of the patching composition, usually a 70 mesh washed silica sand will be employed.

When used, the weight ratio of sand to the dry blend of ingredients constituting the floor patch composition is from about 1:1 or preferably less. The aggregate and the floor patch composition can be added to water separately and are mixed thoroughly to produce a homogeneous slurry. The amount of water to be used in making a slurry with the floor patch composition of the invention is a sufficient amount to provide a workable, flowable (e.g., pumpable), self-leveling slurry having a characteristic “flowability.” Usually from about 20 parts by weight up to about 40 parts by weight water per 100 parts by weight of the dry blend of the flooring composition should be sufficient to provide the necessary flowability. Once the slurry has been applied to the area desired for treatment, the composition is allowed to harden. Once the floor patch has hardened sufficiently, carpet, linoleum, tile, wood, or other such floor coverings may be installed.

The following non-limiting example further illustrates the invention.

### EXAMPLE

A dry blend of ingredients suitable for mixing with water to produce a composition suitable for use as a self-leveling floor patch can be prepared from the following proportion of ingredients:

| | Amount |
|---|---|
| Ingredients | (dry weight percent) |
| Class C fly ash | 83.9 |
| Calcium Aluminate Cement | 8.75 |
| (La Farge) | |
| EVA copolymer binder | 2.0 |
| (Hexion) | |
| Methocel ® 228 | 0.3 |
| (Dow Chemical Company) | |
| Preservative | 0.05 |
| (Vancide ® MZ 96 - R. T. Vanderbilt | |
| Company, Inc.) | |
| Metakaolin clay | 5.0 |
| (BASF) | |

The dry blend of ingredients are mixed with water in an amount of at least 30 parts per 100 parts total solids to produce a self-leveling slurry.

The present invention has been described with reference to specific embodiments for the purpose of describing, but not limiting the invention. Various modifications, which will become apparent to one skilled in the art, and the invention is intended to cover those changes and substitutions that may be made by those skilled in the art without departing from the spirit and the scope of the invention. Unless otherwise specifically indicated, all percentages are by weight. Throughout the specification and in the claims the term “about” is intended to encompass + or −5% and preferably is only about + or −2%

What is claimed is:

1. A floor patch composition comprising a dry blend of ingredients to be mixed with water to form a self-leveling slurry that hydrates to form a floor patch, the composition comprising:
(1) about 70 to 95% by weight of Class C fly ash;
(2) about 1.5 to 15% by weight of a calcium aluminate cement;
(3) about 0.5 to 5% by weight of an organic binder; and
(4) about 0.05 to 1.0% by weight of a cellulose ether.

2. The floor patch composition of claim 1 which also includes (5) about 0.01 to 0.5% by weight of an antimicrobial preservative.

3. The floor patch composition of claim 1 which also includes (6) about 0.5 to 15% by weight of metakaolin clay.

4. The floor patch composition of claim 1 which also includes a set retarder.

5. The floor patch composition of claim 4 wherein the set retarder is sodium citrate.

6. The floor patch composition of claim 1 containing Class C fly ash in an amount of between 80 and 90% by weight.

7. The floor patch composition of claim 6 containing calcium aluminate cement in an amount of between 5 and 12% by weight.

8. The floor patch composition of claim 7 containing an organic binder in an amount of between 1 and 3% by weight.

9. The floor patch composition of claim 1 wherein the organic binder is selected from ethylene-vinyl acetate copolymer or styrene-butadiene rubber.

10. A floor patch composition comprising a dry blend of ingredients to be mixed with water to form a self-leveling slurry that hydrates to form a floor patch, the composition consisting essentially of:
(1) about 70 to 95% by weight of Class C fly ash;
(2) about 1.5 to 15% by weight of a calcium aluminate cement;
(3) about 0.5 to 5% by weight of an organic binder; and
(4) about 0.05 to 1.0% by weight of a cellulose ether;
(5) about 0.01 to 0.5% by weight of an antimicrobial preservative, and
(6) about 0.5 to 15% by weight of metakaolin clay.
